(19) United States
(12) Patent Application Publication
(10) Pub. No.: US 2006/0138701 A1
(43) Pub. Date: Jun. 29, 2006

(54) Method and device for structuring organic layers

(76) Inventors: Jurgen Ficker, Erlangen (DE); Walter Fix, Nurnberg (DE); Andreas Ullmann, Zirndorf (DE)

Correspondence Address: William Squire;Carella Byrne Bain Gilfillan Cecchi Stewart &, Olstein, 5 Becker Farm, Roseland, NJ, 07068, US

(21) Appl. No.: 10/562,989

(22) PCT Filed: Jun. 30, 2004
(86) PCT No.: PCT/DE04/01375

§ 371 Date: Dec. 28, 2005

(30) Foreign Application Priority Data
Jul. 3, 2003 (DE) 103 30 062.7

(51) Int. Cl. B29C 49/00

(52) U.S. Cl. 264/284; 264/293

(57) ABSTRACT

An unpatterned organic layer, which may be an insulator layer of an organic circuit, is patterned with a patterning arrangement, which preferably comprises a device, which patterns the layer at a predetermined temperature and at a predetermined pressure (a compression pressure) into the organic layer. The applying operation permanently patterns the organic layer with the patterning arrangement displaces the contact region of the organic layer displacing the contact region to form permanent open regions comprising depressions and/or holes corresponding to the dimensions of the pattern arrangement and which may be utilized as plated through holes.

The present invention relates to a method and a device for patterning organic layers, and in particular the invention relates to a method for patterning organic layers, preferably insulator layers, in order to obtain plated-through holes in the patterned organic layers.

Organic integrated circuits, that is to say circuits which are based on organic materials or polymeric electrical materials, are suitable for economic production of electrical and electronic circuits in mass applications and disposable products such as, for example, contactlessly readable identification and product (labeling) transponders (radio frequency identification (RFID) transponders or tags) but likewise for high-quality products such as, for example the driving of organic displays.

Integrated circuits are typically constructed from different functional layers. This means that inter-connects are likewise routed in different layer planes. This problem is evident if consideration is given for example to contact-connecting a gate electrode of a first organic field effect transistor (OFET) to the source electrode of a second organic field effect transistor (OFET). In order to realize such an electrical connection, it is necessary to pattern at least one insulator layer between the layer plane of the gate electrode and the layer plane of the source/drain electrodes. The use of conventional photolithography which has been developed and is used for the patterning of inorganic materials is possible only to a very limited extent. The substances and chemicals used for photolithography usually attack the organic layers or dissolve the organic layers, so that the properties of layers are adversely influenced or even destroyed. This occurs in particular during the spinning-on, development and stripping of the photoresist used during the photolithography.

A further technical problem that is likewise solved with plated-through holes is the vertical integration of a plurality of layers of integrated organic circuits. In contrast to inorganic integrated circuits, which require the surface of a single crystal as a substrate, organic circuits do not require a special substrate, that is to say that the circuit planes can be stacked and electrically connected with plated-through holes. In order to obtain a vertical integration of this type, however, at least one isolating layer such as an insulator layer, for example, is required between the circuit planes. The plated-through holes through precisely such layers likewise suffer from the problem described above.

In Applied Physics Letters 2000, page 1478 et seq. (G. H. Gelinck et al.), for solving this problem it is proposed to introduce low-resistance plated-through holes into the field effect transistor structure by means of the photopatterning of photoresist material. For this purpose a different construction of the organic field effect transistors, the so-called “bottom gate” structure is regarded as mandatory. This method cannot be used when producing a “top gate” structure since plated-through holes would have unacceptable high resistances in the region of a few MΩ. Furthermore G. H. Gelinck et al. describe a complex hybrid circuit, that is to say a circuit based on organic field effect transistors and inorganic (traditional) diodes. The hybrid structure with “bottom gate” transistors cannot be used economically for complex circuits. This method is practicable only in the context of research and development since it cannot be adapted to the requirements of a fast and continuous production process in the context of series production.

One object of this invention is to provide a method which makes it possible to pattern an organic layer of an organic circuit in a time-efficient and continuous or semicontinuous process.

A further object of this invention is to apply the method to the formation of plated-through holes in order to obtain a time-efficient and continuous or semicontinous process for the formation of plated-through holes.

The objects are achieved by means of the independent claims 1 and 8. Advantageous designs of embodiments of the invention are described in the dependent claims.

A first aspect of the invention provides a method for patterning an unpatterned organic layer. The method is advantageously suitable for patterning an insulator layer of organic circuits. Patterning means at a pre-determined temperature are pressed at a predetermined pressure (a compression pressure) into the organic layer. The pressing-in operation is suitable for permanently patterning the organic layer using the patterning means.

According to the invention, a layer-forming substance of the organic layer is chosen in such a way that the organic layer is opened permanently under the action of the patterning means during the pressing-in. The patterning means are preferably pressed into the organic layer over a predetermined time period.

Furthermore, the patterning means are preferably arranged on a planar carrier. The carrier may advantageously be embodied in plate-type fashion with relieflike patternings. The projecting structures of the relieflike patternings in this case serve as the patterning means for patterning the organic layer.

The patterned organic layer preferably has depressions in accordance with the patterning means. In particular, the depressions are essentially continuous, that is to say the depressions are continuous as far as a layer which is at least partly covered by the unpatterned or finally patterned organic layer, and uncover regions of said layer. The depressions are suitable according to the invention for forming plated-through holes in the depressions which have contacts to the uncovered regions of the layer which is at least partly covered by the unpatterned or finally patterned organic layer.

One advantage of the solution according to the invention is that the organic layer, in particular the organic insulator layer, is patterned independently of its application. It is typically necessary to ensure that an insulator layer in an integrated organic circuit is formed such that it is very thin (<500 nm) and free of defects. Methods and devices which could apply the insulator layer in patterned fashion (e.g. printing techniques) do not lead to very thin layers free of defects; only thick layers (>1 μm) can thereby be applied. On the other hand, unpatterned layers can be applied such that they are very thin and free of defects. According to the invention, the layer application and layer patterning are carried out in an optimized manner in separate processes, the invention specifically relating to the layer patterning.

An additional advantage of the invention is that the patterning according to the invention requires no solvents whatsoever which makes this method cost-effective and environmentally friendly.

A further advantage of the invention is the possibility of configuring the method according to the invention in such a way that said method can advantageously be integrated into a continuous or semicontinous and fast production process.

A further aspect of the invention provides a device for patterning organic layers. The device according to the invention is suitable in particular for patterning organic insulator layers of organic circuits. For this purpose, the device has patterning means having predetermined dimensions. Said patterning means can be pressed at a predetermined temperature and at a predetermined pressure into the organic layer. By pressing the patterning means into the organic layer, the latter is permanently patterned.

Preferably, a layer-forming substance or layer-forming substances of the organic layer is or are chosen in such a way that the organic layer is opened permanently under the action of the patterning means, that is to say during the pressing-in of the patterning means.

Furthermore, the patterning means are preferably arranged on a planar carrier. As an alternative, the patterning means are arranged on a planar, flexible carrier, which is in turn arranged circumferentially on a roll-type carrier or basic body.

The organic layer or the layer-carrying substrate is advantageously conveyed by means of a conveying device synchronously with a circumferential speed of the roll-type carrier or basic body. A device, preferably a mechanical device, furthermore advantageously makes it possible to press the patterning means into the organic layer at the predetermined pressure. In addition, the patterning means can be heated to the predetermined temperature by means of a device.

In particular, the use of flexible or pliable carriers with patterning means, similar to those used in the printing industry for relief printing methods, constitutes a significant advantage of the device. These pliable carriers can be mounted on rolls or rollers in order thus to integrate the method set out above in accordance with one embodiment of the invention, e.g. into a web-fed printing machine.

A further cost-effective element is that the carriers can be converted rapidly since producing the elevations on the carriers through standardized etching methods constitutes a customary process.

A further advantage of the invention is the possibility of configuring the device according to the invention in such a way that said device can advantageously be integrated into a continuous or semicontinuous and fast production process.

The device according to the invention in accordance with one embodiment of the invention is suitable in particular for carrying out the method according to the invention for patterning organic layers that is described in detail above.

The term “organic materials” is to be understood to mean all types of organic, organometallic and/or inorganic plastics with the exception of the traditional semiconductor materials based on germanium, silicon, etc. As well, the term “organic material” is likewise intended not to be restricted to carbon-containing material; rather materials such as silicones are likewise possible. Furthermore, “small molecules” can likewise be used beside polymeric and oligomeric substances. It shall likewise be understood in the context of this invention that organic layers are obtained from these layer-forming materials or substances. Furthermore, organic components composed of different functional components, in connection with the present invention, are distinguished by at least one organic functional component, in particular an organic layer.

Details and preferred embodiments of the subject matter according to the invention emerge from the dependent claims and also the drawings, with reference to which exemplary embodiments are explained in detail below, so that the subject matter according to the invention becomes clearly evident. In the drawings:

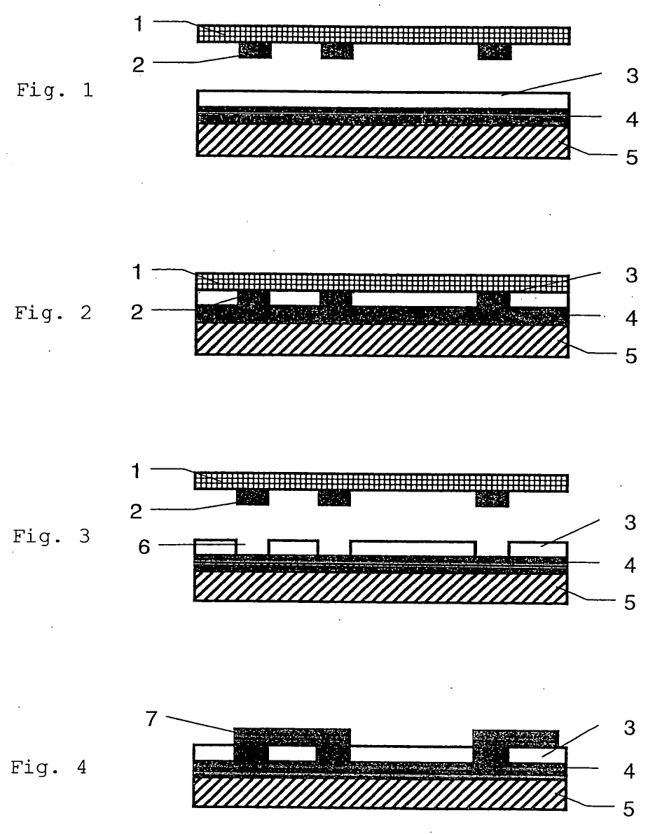

FIG. 1 shows a first exemplary process step for the semicontinuous patterning of an organic layer of an organic circuit in accordance with one embodiment of the invention;

FIG. 2 shows a second exemplary process step in accordance with one embodiment of the invention;

FIG. 3 shows a third exemplary process step in accordance with one embodiment of the invention;

FIG. 4 shows a fourth exemplary process step in accordance with one embodiment of the invention; and

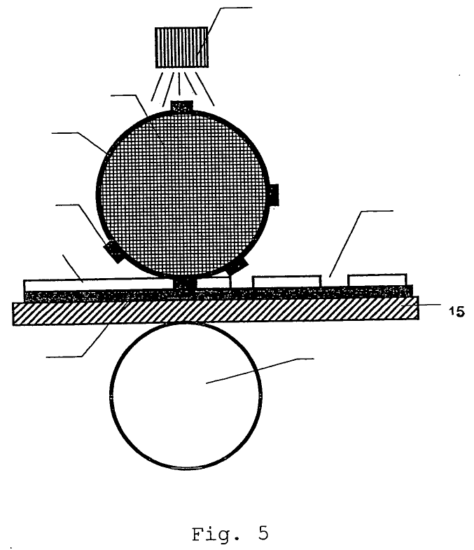

FIG. 5 shows a device for patterning an organic layer of an organic circuit in accordance with one embodiment of the invention.

FIGS. 1 to 4 illustrate by way of example individual process steps for the semicontinous patterning of an organic layer of an organic circuit in accordance with one embodiment of the invention.

FIG. 1 illustrates a substrate 5 which carries a first layer 4 and a second layer 3. The first layer 4 may be composed for example of metallic and/or organic layer portions. In particular, the layer 4 may comprise organic and/or metallic interconnects, source or drain electrodes and organic semiconductor layers. Said layer 4 is covered by the second layer 3, which is an insulator layer 3, in particular.

The substrate is advantageously an organic substrate, preferably a plastic film, and in particular a polyester film. The semiconductor layer is advantageously based on an organic semiconducting substance. The semiconductor layer may be formed, in particular, from one of the polymeric substances such as, for example, polyalkylthiophene, poly-di-hexyl-terthiophene (PDHTT) and polyfluorene derivates. The insulator layer is advantageously an organic electrically insulating insulator layer such as, for example, polymethyl methacrylate (PMMA) or polyhydroxystyrene (PHS). Gold, polyaniline (PANI) or doped polyethylene (PEDOT) are appropriate as organic conductive substances, in particular as interconnects.

Furthermore, FIG. 1 illustrates a carrier or compression plate 1 having a multiplicity of projections 2. The projections 2 are preferably formed in cylindrical fashion and advantageously have essentially identical dimensions. The diameter of the projections 2 is in a range of 10 to 100 μm, for example and the height is furthermore in a range of a few micrometers. Such a carrier or compression plate 1 with projections 2 may be produced from an inorganic carrier plate, for example a copper plate, for example by means of lithography and/or etching processes.

In accordance with FIG. 2, the carrier plate is pressed for a predetermined time duration at a predetermined pressure onto the substrate 5 or the layer 3 arranged at the top on the substrate 5. At the contact points, the layer-forming substance of the layer 3 retreats, thus giving rise to depressions 6 or holes 6 which essentially correspond in terms of their positions and their dimensions to the positions and dimensions of the projections 2 on the carrier plate 1. That is to say that the organic layer 3 is patterned in accordance with the configuration of the carrier plate 1 or the configuration and arrangement of the projections 1 exposed by the carrier plate 1.

In order to ensure the formation of the depressions 6 at the predetermined pressure during a predetermined time duration, the carrier plate with projections 2 is preheated to a predetermined temperature before the pressing operation. The heating of the carrier plate 1 with projections 2 may be effected for example by electrical heating or by means of radiation heating.

As shown in FIG. 3, the carrier plate and the layer-carrying substrate 5 are separated from one another after the predetermined time duration. The depressions 6 and holes 6 that have been formed by the projections in the layer 3 remain in the organic layer 3 so that the layer 3 is now present in patterned fashion.

The patterning of the layer 3 may then be followed by further production process steps. It is thus possible, by way of example, for a next layer to be applied, which can furthermore be patterned in application- and production-specific fashion. FIG. 4 illustrates such a further patterned layer. In accordance with FIG. 4, by way of example, a second interconnect plane in the form of a conductive metallic or organic layer 7 is applied in patterned fashion, which, in accordance with the patterned organic layer 3, is electrically contact-connected to the layer 4 through the depressions 6 formed. Said electrically conductive layer 7, may, for example include gate electrodes for organic field effect transistors (OFETs).

The process steps described above, illustrated in accordance with FIG. 1 to FIG. 3, for patterning an organic layer, in particular the organic layer 3, may be referred to as a semicontinuous method. The patterning means is embodied in the form of the carrier or compression plate 1, which can pattern a predetermined area of the organic layer in a compression or pressing operation. Afterward, an organic layer subsequently positioned below the carrier or compression plate 1 can be patterned.

FIG. 5 illustrates a device for patterning an organic layer of an organic circuit in accordance with one preferred embodiment of the invention.

A roll 10 or a roller 10 is used as the patterning means. The surface of the roll is preferably provided with a pliable or flexible carrier or compression plate 11, which, analogously to the carrier or compression plate 1 described above, likewise has projections 12 serving for patterning an organic layer 13. The production method described above may accordingly likewise be used for the carrier or compression plate 11. The dimensions of the projections 2 and of the projections 12 likewise correspond to one another.

In order to transfer the structure of the compression plate 11 that is carried by the roll 10 to the organic layer 13, the substrate 15 carrying the organic layer 13 is moved circumferentially synchronously with the circumferential speed of the roll 10 by means of a conveying device, so that the projections 12 of the compression plate 11 that are carried by the roll pattern the organic layer 13 analogously to the method described above. The conveying device is a suitable mechanical device, such as, for example, a counterpressure roll 18, which is advantageously connected to a belt conveying device (not shown) for synchronously conveying the substrate 15, so that the substrate 15 and consequently likewise the organic layer 13 are conveyed synchronously with a circumferential speed of the roll 10 or of the roll 10 provided with the compression plate 11. A further mechanical device (not shown) may serve for enabling, setting and regulating the predetermined (pressing-on) pressure. Said mechanical device may be provided both on the counterpressure roll 18 and on the roll 10 and be based on an adjustable spring element, by way of example. The projections 12 or the compression plate 11 are heated by means of a heat source, which may be embodied in accordance with FIG. 5 in the form of a thermal energy source that is distinguished by emission of energy. This may be an infrared energy source (a heating lamp 17), by way of example. It is likewise possible to supply energy by means of a direct electrical resistance heating of the surface of the compression plate 11 or of the projections 12 or an energy source integrated into the roll is possible. With this embodiment, it is possible to realize a fast and a continuous process for producing plated-through holes.

To summarize, plated-through holes are pressed into organic layers, in particular insulator layers, with the aid of heat and pressure by means of a relieflike (flexible) plate with elevations, designated above as carrier or compression plate with projections, at the locations of the plated-through holes. In this case, the insulator layer is opened at the contact points, thereby producing depressions or holes in the insulator layer. In a subsequent step, for example application of the next electrode layer, it is possible to enable two electrode planes to be connected. It is thus possible, in an integrated organic circuit, by way of example, both for transistors to be connected to one another and for transistors to be connected to other components such as diodes, capacitors or coils. It is likewise possible to realize a stacking of a plurality of layers of integrated organic circuits which can be electrically connected to one another by an insulator isolating layer with plated-through holes.

1. A method for patterning an unpatterned organic layer comprising a layer-forming substance for use in organic circuits, the method comprising:
applying a patterning device at a predetermined, elevated temperature and at a predetermined pressure to contact points on the organic layer, the layer-forming substance of the organic layer retreating from the contact points in response to the applied pressure and elevated temperature to thereby form depressions and/or holes in the organic layer.

2. The method as claimed in claim 1, including choosing a the substance which forms the organic layer such that the organic layer is opened permanently under the applying action of the patterning device.

3. The method as claimed in claim 1 including effecting the applying step over a predetermined time period.

4. The method as claimed in claim 1 including supporting the patterning device on a planar carrier.

5. The method as claimed in claim 1 including forming the patterned organic layer depressions and/or in accordance with a pattern on the patterning device.

6. The method as claimed in claim 5, including providing a further layer covered by the organics layer, the depressions and/or holes essentially extending continuously to the further layer.

7. The method as claimed in claim 5 wherein including forming the depressions and/or holes for forming plated-through holes.

8. A device for patterning an organic layer comprising a layer-forming substance for use in an organic circuits, the device comprising:
a support; and
a patterning arrangement coupled to the support and having predetermined dimensions, the patterning arrangement being arranged for being heated to a predetermined elevated temperature and for receiving a predetermined pressure for containing the layer-forming substance of the organic layer at the elevated temperature and predetermined pressure to displace the layer-forming substance such that depressions and/or holes are formed in the layer-forming substance, which depressions and/or holes essentially correspond to the dimensions of the patterning arrangement.

9. The device as claimed in claim 8 wherein, the layer-forming substance which forms the organic layer is opened permanently under the action of the patterning arrangement.

10. The device as claimed in claim 8 wherein the support comprises a planar carrier.

11. The device as claimed in claim 8 wherein the support is a planar, flexible carrier, which is arranged circumferentially on a roll-type carrier.

12. The device as claimed in claim 11 wherein the roll-type carrier has a circumferential speed, the device including a conveying device for conveying the organic layer essentially synchronously with the circumferential speed of the roll-type carrier.

13. The device as claimed in claim 8 including a further device for pressing the patterning arrangement into the organic layer at the predetermined pressure.

14. The device as claimed in claim 8 including a further device for heating the
patterning arrangement to the predetermined temperature.
